(19) United States
(12) Patent Application Publication
(10) Pub. No.: US 2005/0024359 A1
(43) Pub. Date: Feb. 3, 2005

(54) Terahertz phase shifter or retarder based on magnetically controlled birefringence in liquid crystals

(76) Inventors: Ci-Ling Pan, Hsinchu (TW); Ru-Pin Chao, Hsinchu (TW); Chao-Yuan Chen, Chu-Pei City (TW)

Correspondence Address: PERKINS COIE LLP, P.O. BOX 2168, MENLO PARK, CA, 94026, US

(21) Appl. No.: 10/706,097

(22) Filed: Nov. 12, 2003

(30) Foreign Application Priority Data
Jul. 29, 2003 (TW) 092120650

(51) Int. Cl. G06T 1/00

(52) U.S. Cl. 345/418

(57) ABSTRACT

The present invention enables a means of continuously shifting the phase of electromagnetic waves in the THz (0.1 to 10 THz, 1 THz=10⁻¹² Hz) or sub-millimeter wave range. It is based on magnetically controlled birefringence of liquid crystals. The device consists of an assembly of a liquid crystal cell and rotatable magnets. By varying the angle of the magnet with respect to the incident THz wave, desired phase shift or delay can be achieved. To increase the amount of phase shift, the device employs multiple liquid crystal cells in a compact sandwich structure.

### BACKGROUND OF THE INVENTION

1. Field of the Invention

The present invention relates to a phase shifter, more specifically, to the implement of liquid crystal to providing a device with continuous adjusting phase shift or delay, i.e. a phase shifter, for various applications in THz (1 THz=10⁻¹² Hz) electromagnetic wave or sub-mm wave.

2. Description of Relative Prior Art

The applications of wireless electromagnetic wave and microwave such as mobile phone communication and wireless network has to be the most important industry in recent years. The trend of this area is developing toward higher frequencies, it will use millimeter wave even sub-millimeter wave in the future. Because of the shortage of wave source and detector, there is very few application of electromagnetic wave in sub-millimeter wave band. But in the past decade, due to the gradual maturing of laser excited coherent THz wave technology, the THz wave has shown great development potential in fields including time-domain spectroscopy, Thz imaging and medical application. Moreover, THz communication and phase array radar also become feasible. The above applications all need THz optic devices such as polarizer, filter, phase shifter and modulator, etc., for signal processing.

In the published documents, The phase adjusted by liquid crystal only used in microwave and millimeter wave range, not in sub-millimeter wave band, example such as in the articles “Liquid crystal millimeter wave electronic phase shifter”, K. C. Lim et al., Appl. Phys. Lett., August 1993; in the U.S. Pat. No.5,184,233 to Lim Khoon C et al.; and in the U.S. Pat. No. 5,537,242 to Lim Khoon Cheng, the frequency range is microwave and millimeter wave but not sub-millimeter wave band; the structure is by using wave guide, not a bulk device; and the magnetic field is used to stabilize the orientation of the liquid crystal. In the U.S. Pat. No. 5,451,567 to Das Satyendranath, using ferroelectric materials, suitable in RF range. In the U.S. Pat. No. 5,689,314 to Mercer Carolin R, which is a interferometer using liquid crystal as the phase shifter, but the wave length is in the optical light range. In the article “Modeling, Synthesis and Characterization of a Millimeter-Wave Multilayer Microstrip Liquid Crystal Phase Shifter”, Fréederic Guéin et al., Jpn. J. Appl. Phys. Part 1, 36 (7A), July 1997, which emphasize the synthesis of liquid crystal and modeling of wave-guide-type phase shifter, the application wave length is also millimeter wave, not for sub-millimeter wave. In the article “Thick polymer-stabilized liquid crystal films for microwave phase control”, Hideo Fujikake et al., J. Appl. Phys. 89 (10), 15 May 2001, emphasized the use of polymer-stabilized liquid crystal, also operated at microwave frequencies. The difference between articles “An optically controllable terahertz filter”, I. H. Libon et al., Appl. Phys. Lett. 76, 2821 (2000); and “Terahertz phase modulator”, R. Kersting et al., Electron Lett. 36, 1156 (2000), is by using different quantum well structure to have adjustable phase shift. The disadvantage is too small an adjustable range and very low operation temperature. In these two papers, for example, the adjusted value is smaller than 40°, the operation temperature is far lower than room temperature (about 40° K). This is not convenient and thus limited its application.

Based on the forgoing, there is a need for a continuously adjustable THz wave band phase shifter and is a THz wave device for practical application such as, providing a continuously adjustable phase shifter or retarder in Tera-Hz wave band (0.1 THz to 10 THz).

The present invention provides, continuously and widely adjustable phase shift, the operation temperature is based on the requirement of specific applications by simply selecting a suitable liquid crystal. In one embodiment, the liquid crystal selected can be used at room temperature. It is much easier to use in design applications as compared to the THz wave phase shifter of the prior art.

### SUMMARY OF THE INVENTION

The object of the present invention is to provide a phase shifter used in THz wave band (0.1 Thz to 10 THz) with continuously and widely adjustable phase shift.

Another object of the present invention is to provide a continuously adjustable THz wave band phase shifter with operation temperature based on the requirement, can be used in room temperature, and more easy to use in a wide range of applications.

In order to achieve the above objective and improve the drawbacks of a conventional phase shifter, the present invention provides a continuous phase adjustable phase shifter used in THz wave band, the phase shifter comprising: a magnetic field generating mechanism with adjustable direction; a liquid crystal cell. Said direction variable magnetic field mechanism further comprise other shape of permanent magnets, multiple magnets and electromagnets, capable of generating adjustable magnitude and direction of said magnetic field. Said mechanism further comprises implement action of two or more permanent magnets by adjusting the distance of separation of the magnets to generate adjustable magnitude and direction of said magnetic field. Said multiple magnets combination further comprise implement action of two or more permanent magnets by adjusting the distance of separation of the magnets to generate adjustable magnitude and direction of said magnetic field. Said liquid crystal cell further comprising multiple layer structure, such as sandwich structure, to provide an adjustable range of phase shift, and keep the stability of the liquid crystal. Said liquid crystal cell is further comprising the liquid crystal cell whose molecules alignment is further comprising liquid the crystal with negative diamagnetic anisotropy.

### BRIEF DESCRIPTION OF THE DRAWING

FIG. 1(A) is a schematic diagram of a three dimensional structure of one preferred embodiments of the present invention.

FIG. 1(B) illustrates the liquid crystal cell corresponding to FIG. 1(A).

FIG. 2(A) illustrates the comparison of the measurement result and the theoretical values of a liquid crystal cell with liquid crystal thickness of 0.93 mm. The value points are practical measurement data and the solid lines are the theoretical results.

FIG. 2(B) illustrates the comparison of the measurement result and the theoretical values of a liquid crystal cell with liquid crystal thickness of 1.53 mm. The symbols are practical measurement data and the solid lines are the theoretical results.

FIGS. 3(A) and (B) illustrate a schematic diagram of a 3-dimensional structure of the second embodiment of the present invention.

### DETAIL DESCRIPTION OF THE PRESENT INVENTION

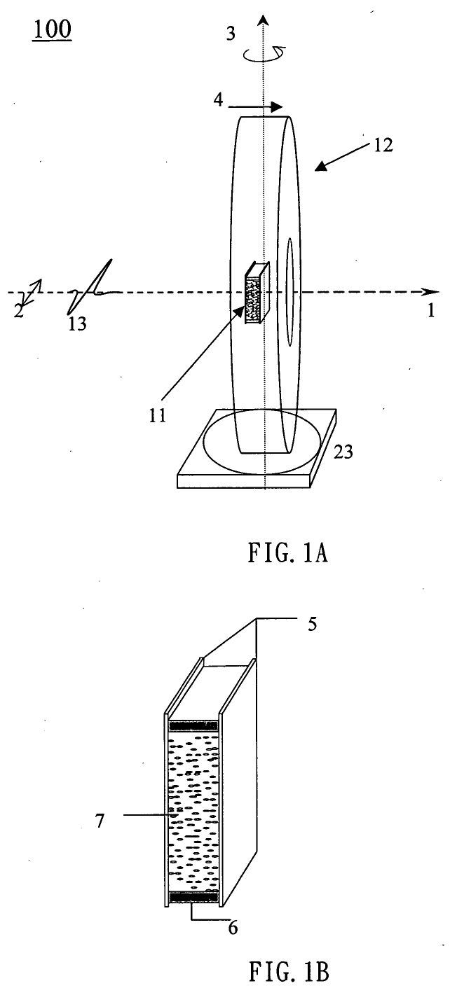

Please refer to FIG. 1(A), FIG. 1(A) is a schematic diagram of a three dimensional structure of one preferred embodiments of the present invention. The phase shifter 100 of this embodiment comprises a sample liquid crystal cell 11, a magnet 12 providing the magnetic field, some fixtures for fixing the sample 11. The magnet 12 can be rotated around axes 3 to provide a magnetic field 4 with variable orientation to change the orientation of the liquid crystal molecule in the cell. When the traveling direction 1 of the THz wave 13 and the polarized direction 2 is as shown in FIG. 1(A), the corresponding refractive index of the liquid crystal in the liquid crystal cell will be changed according to the angle of the magnetic field 4, the equivalent optical path of the THz wave is also changed, thus provides a continuously adjustable phase shift.

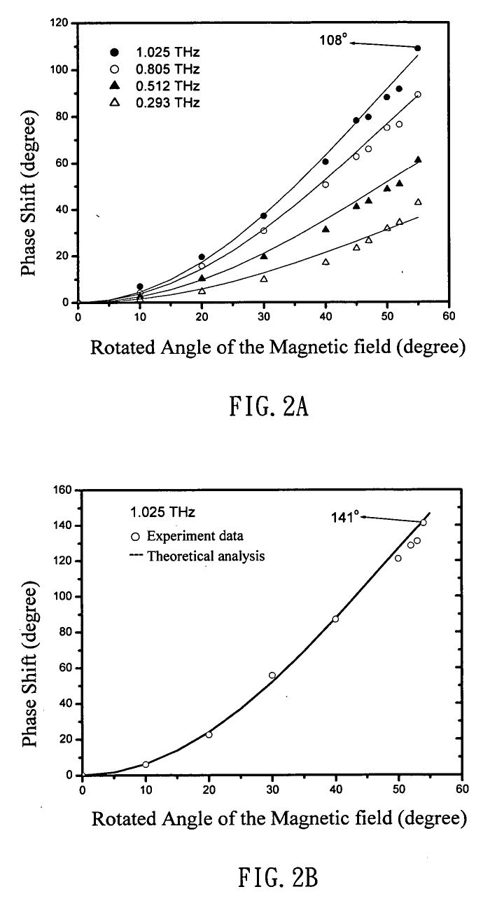

Refer to FIG. 1(B), FIG. 1(B) illustrates the liquid crystal cell 11 corresponding to FIG. 1(A). The liquid crystal cell 11 is constructed by using two quartz plates (or other transparent substrate) 5 and a spacer 6 to form a chamber in which liquid crystal 7 is injected therein. The liquid crystal used in the present invention is 5CB (4′-n-pentyl-4-cyanobiphenyl from Merck). Before filling the liquid crystal, a thin film of DMOAP (dimethyloctadecyl-(3-trimethoxysilyl)-proplammonium-chloride) is spin coated on the quartz plates such that the liquid crystal 7 will be oriented vertically in the cell 11, as shown in FIG. 1(B). The present invention also has its corresponding theoretical modeling, the phase delay δ can be represent by:

$$δ ( θ ) = {\int }_{0}^{L} \frac{2 π f}{c} Δ {n}_{eff} ( θ , z ) ⅆ z \qquad ( 1 )$$

where θ is the angle between the magnetic field direction and the normal line vertical to the substrate; L is the total thickness of the molecular layer of the liquid crystal; c is the speed of light; Δn_{eff} is the effective birefringence of liquid crystal; and z is the distance from the liquid crystal molecular to the first substrate. The magnet provide a magnetic field of 0.5 Tesla to the liquid crystal cell. This is a very strong magnetic field for orienting the liquid crystal molecules, In other word, we have enough reason to assume that when the magnetic field turn to a different direction from the easy direction of the liquid crystal, the liquid crystal molecular will be reoriented parallel to the direction of the magnetic field. The phase delay δ, then can be rewritten as:

$$δ ( θ ) = 2 π L \frac{f}{c} \{ {[ \frac{{cos}^{2} ( θ )}{{n}_{o}^{2}} + \frac{{sin}^{2} ( θ )}{{n}_{e}^{2}} ]}^{\frac{1}{2}} - {n}_{o} \} \qquad ( 2 )$$

where nₒ and nₑ are ordinary and extra-ordinary refractive indices of the liquid crystal respectively. We have compared the results of the theoretical modeling and the experiment data of the embodiment of the present invention. Please refer to FIGS. 2(A) and 2(B), The vertical axis is the phase shift quantities, and the horizontal axis is the rotated angle of the magnetic field. FIG. 2(A) illustrates the comparison of the measurement result and the theoretical values of a liquid crystal cell with liquid crystal thickness of 0.93 mm. The symbols are practical measurement data and the solid lines are the theoretical results. We found that there are very good agreement between experiment and theoretical results. Maximum phase delay of 108 degree can be obtained at a frequency of 1.025 THz. The thickness of the liquid crystal cell is 1.32 mm for FIG. 2(B), the agreement between experiment and theoretical results is also very good. Maximum phase delay of 141 degree can be obtained at a frequency of 1.025 THz.

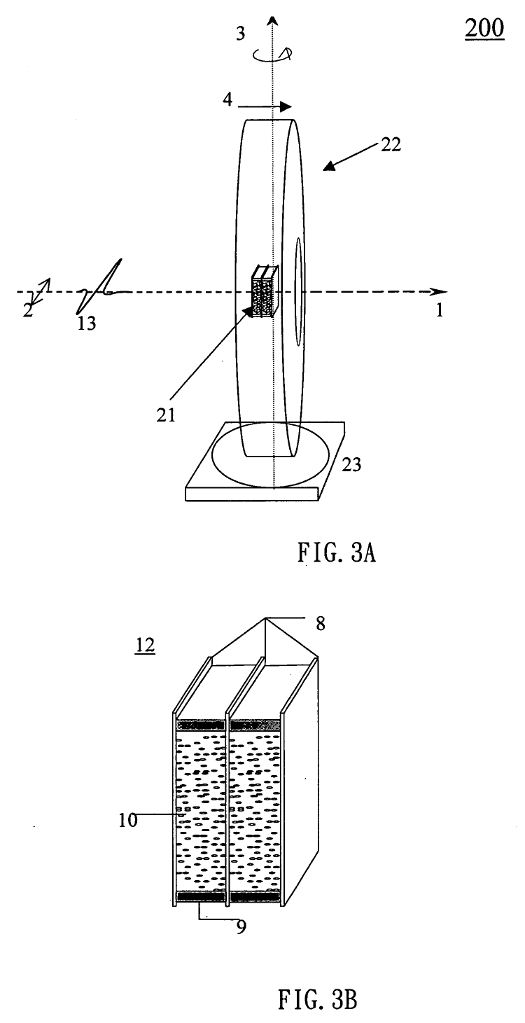

FIGS. 3(A) and (B) illustrate a schematic diagram of a 3-dimension structure of the second embodiment of the present invention. The structure of the phase shifter 200 of the second embodiment is similar to that of the first embodiment. However, the liquid crystal cell 12 located in the magnetic field is different. The second embodiment adopts a sandwich structure. Please refer to FIG. 2(B). The liquid crystal cell 21 of the second embodiment made use of three quartz plates and two spacers, which results one more chamber than the first embodiment. The implementation of the sandwich structure increases the stability of the orientation of the liquid crystal, also increases the optical path length for the THz electromagnetic wave traversing the liquid crystal, so as to increases the adjustable range of the phase shift. The liquid crystal used in this embodiment is also 5CB (Merck).

Although specific embodiments of the invention have been disclosed, the specification and drawings are, accordingly, to be regarded as an illustration rather than a restrictive sense. It will, however, be understood by those having skill in the art that minor changes can be made to the form and details of the specific embodiments disclosed herein, without departing from the spirit and the scope of the invention. For example, in the preferred embodiment of the present invention, although a ring-shaped magnet tool is used to provide the magnetic field, it is not limit to this type. It may consist of multiple sets of magnets, any shape of permanent magnets or electromagnets, Alternatively, the orientation of the liquid crystal cell can be parallel to the substrate, or other alignment forms.

The embodiments presented above are for purposes of example only and are not to be taken to limit the scope of the appended claims.

1. A terahertz phase shifter based on magnetically controlled birefringence in liquid crystal, the phase shifter comprising:
a magnetic field generating mechanism with adjustable direction, the magnet can be rotated around an axis to provide a magnetic field of adjustable direction, thus change the orientation of the liquid crystal molecules in a liquid crystal cell;
a liquid crystal cell through which the THz wave propagates, the corresponding reflective refraction index of the liquid crystal will be changed according to the angle of the magnetic field, the equivalent optical path of the THz wave is also changed, thus providing a continuously adjustable phase shift.

2. A terahertz phase shifter as recited in claim 1, wherein said adjustable direction magnetic field mechanism further comprising other shape of permanent magnets capable generating adjustable magnitude and direction of said magnetic field.

3. A terahertz phase shifter as recited in claim 1, wherein said direction-adjustable magnetic field mechanism further comprising other shapes and configuration of magnets capable generating adjustable magnitude and direction of said magnetic field.

4. A terahertz phase shifter as recited in claim 1, wherein said direction-adjustable magnetic field mechanism further comprising other shapes and configuration of electromagnets capable generating adjustable magnitude and direction of said magnetic field.

5. A terahertz phase shifter as recited in claim 1, wherein said multiple magnets combination further comprising implementation of two or more permanent magnets by adjusting the distance of separation of the magnets to generate adjustable magnitude and direction of said magnetic field.

6. A terahertz phase shifter as recited in claim 1, wherein said electromagnets further comprising one or more electromagnet combination, by adjusting the magnitude of the excitation current and/or the angle of the coil to generate adjustable intensity and direction of said magnetic field.

7. A terahertz phase shifter as recited in claim 1, wherein said liquid crystal cell further comprising a multiple layer structure, such as a sandwich structure, to provide the adjustable range of phase shift, and keep the stability of the liquid crystal.

8. A terahertz phase shifter as recited in claim 1, wherein said liquid crystal cell further comprising the alignment of the liquid crystal molecules which are parallel to the substrate.

9. A terahertz phase shifter as recited in claim 1, wherein said liquid crystal of said liquid crystal cell further comprising any liquid crystals with negative diamagnetic anisotropy.
